(19) United States
(12) Patent Application Publication
(10) Pub. No.: US 2024/0132377 A1
(43) Pub. Date: Apr. 25, 2024

(54) Adsorbent Structures of Activated Alumina and Metal Carbonates and Methods of Use for the Removal of Phosphates and Ammonia from Water

(71) Applicant: U.S. Environmental Protection Agency, Washington, DC (US)

(72) Inventor: Mallikarjuna Nadagouda, Mason, OH (US)

(73) Assignee: U.S. Environmental Protection Agency, Washington, DC (US)

(21) Appl. No.: 18/333,161

(22) Filed: Jun. 12, 2023

Related U.S. Application Data
(63) Continuation-in-part of application No. 17/151,979, filed on Jan. 19, 2021.
Application No. 17/151,979 is a continuation-in-part of application No. 16/514,990, filed on Jul. 17, 2019, now abandoned.

(51) Int. Cl. C02F 1/28; B01J 20/04; B01J 20/08; B01J 20/28

(52) U.S. Cl. CPC C02F 1/281; B01J 20/043; B01J 20/08; B01J 20/28019; B01J 20/2803; B01J 20/28059; C02F 2101/105

(57) ABSTRACT

High surface area activated alumina and magnesium carbonate structures are used to adsorb aqueous phosphate and ammonia for recovery and repurposing as a fertilizer. A binder is utilized to aid in the formation of useful structures and to increase porosity and the available surface area for adsorption upon calcining.

### CROSS REFERENCE TO RELATED APPLICATIONS

This Applications claims priority from and is a Continuation-in-Part of U.S. patent application Ser. No. 16/514,990 filed on Jul. 17, 2019 and U.S. patent application Ser. No. 17/151,979 filed Jan. 19, 2021.

### TECHNICAL FIELD

The field of technology generally relates to methods for separating and recovering phosphates and ammonia from water.

### BACKGROUND

As the limiting nutrient in most waterways, increased phosphate (PO₄³⁻) concentrations can promote accelerated eutrophication. Eutrophication is a process that occurs when a body of water, such as a lake, river, or ocean, becomes excessively rich in nutrients, which has a range of environmental and economic impacts because it promotes the rapid growth of algae and other aquatic plants.

The primary cause of eutrophication is the runoff of nutrients from human activities such as agriculture, industrial processes, and urban development. Fertilizers used in agriculture, for example, contain high levels of nitrogen and phosphorus, which can be washed into water bodies through rainfall or irrigation systems. Similarly, untreated sewage and wastewater can contribute to nutrient loading in water systems.

Eutrophication is a significant environmental issue that can have severe impacts on the ecological balance of aquatic ecosystems, leading to the loss of biodiversity, reduced water quality, and disruption of various ecosystem services. Various management strategies can be implemented to inhibit eutrophication. These include reducing nutrient inputs from agricultural practices through improved fertilizer management, promoting responsible wastewater treatment and stormwater management, and implementing buffer zones or wetlands to capture and filter nutrients before they reach water bodies. Eutrophication can also cause aesthetic problems in water bodies.

Eutrophication leads to increased water treatment costs, decreased recreational value; but notably, the proliferation of algal blooms. Some of these blooms produce cyanotoxins like microcystins and cylindrospermopsin which can be detrimental to both human and aquatic life. Though chemical precipitation and biological treatments are commonly used methods for the remediation of PO₄³⁻, problems including costs, sludge production and stability/reliability issues have led to the research of alternative methods for the removal of PO₄³⁻ from waterways.

While viewed as a pollutant at excessive concentrations (i.e., >20 μg L−1), phosphate (PO₄³⁻), the primary species of phosphorus in the environment, is necessary for a range of commercial purposes including the production of agricultural fertilizers, animal feeds, and chemical pesticides. The Environmental Protection Agency (EPA) limit for acceptable phosphorus levels in water is 0.1 mg/L or lower.

Phosphate reserves are quickly being depleted, therefore the recovery and reuse of PO₄³⁻ is an essential component of remediating the depletion of natural phosphate resources. Adsorption is a technique which can remove PO₄³⁻ from aqueous suspensions and, in some instances, permit its recovery and reuse. Adsorbents ranging from modified iron oxide, to calcined waste eggshells, to magnesium modified corn biochar have been investigated for phosphate adsorption. However, adsorption of PO₄³⁻ is problematic because desorption can be difficult and expensive. The use of highly adsorptive fine powders which can desorb phosphate after recovery is a growing area of study and their removal from solution after adsorption is challenging. Therefore, the synthesis of highly adsorptive, inexpensive, granular sized sorbents which can safely recycle phosphate back into the environment in a controlled manner would be extremely beneficial to the problems of phosphate pollution and conservation.

Adsorption is a surface-based phenomenon resulting in the adhesion of an adsorbate on the surface of an adsorbent through covalent bonding or electrostatic interactions. Unlike chemical precipitation and biological removal processes, adsorption is unique in that it can remove contaminants over a wide pH range and at low concentrations. A wide variety of materials have been investigated for the adsorption of phosphate including metal oxides, waste materials, zeolites, and polymers. Lesser-studied materials for phosphate sorption are carbonates. Previous studies have explored the use of calcium carbonates (CaCO₃) as phosphate binders to decrease phosphate concentrations in aquatic environments. Likewise, a wide variety of materials can adsorb ammonia in water.

### SUMMARY

Structures made from metal carbonates having very low water solubility (e.g., 0.11 g/L at 25° C. for MgCO₃) can be utilized to remove phosphates and ammonia from water and facilitate their recovery. Powdered metal carbonates, e.g., alkaline earth metal carbonates such as MgCO₃ and lanthanoid carbonates such as La₂(CO₃)₃, are mixed with a binder and pressed into structures. The binder and any diluent are then removed by calcining the pressed structure which increases its porosity, thus increasing the surface area available for phosphate and ammonia adsorption. Naturally occurring carbonate compounds may also be utilized and shaped accordingly where they have sufficient porosity and when the strength of the structure is not a significant consideration for the application in which the resulting structure is to be utilized. Blending alkaline earth metal carbonates, e.g., MgCO₃, with activated alumina (Al₂O₃) improves the thermal and mechanical stability of pressed and calcined porous adsorbent structures without significantly degrading adsorption.

Phosphate and ammonia adsorbent structures can be used as linings, channels, load bearing structures, or other constructs with surfaces that can be placed in contact with wastewater which could benefit from the capture of phosphates and ammonia. Moreover, the structures can be formed into pellets aggregated into a flow-through bed. Aggregates may be placed within porous housings for use in situ for low flow settling ponds and tanks or in high flow applications such as effluent stream. The aggregates may also be used to create adsorbent beds in flow-through arrangements such as pipes and columns. These porous bags of pelletized carbonates may also be placed within open cell foam structures to filter common debris (e.g., leaves, wood, and insects) that could potentially interfere with the porosity of the pellet bag or clog the pores of the aggregate adsorbent. The phosphorous and ammonia can be subsequently reclaimed from the spent structures and used in agriculture as fertilizer.

### BRIEF DESCRIPTION OF THE FIGURES

FIG. 1 is a table depicting the resulting molar ratios achieved with various samples in Example 1 herein.

FIG. 2 demonstrates the adsorption capacity of the formed pellets under various experimental conditions.

FIG. 3 depicts a pelletized metal carbonate for use as an aggregate.

FIG. 4 depicts SEM images of pellets formed with and without cellulose, before and after phosphate adsorption.

FIG. 5a depicts XRD analysis of MgCO₃ calcined pellets MgCO₃ pellets formed with varying quantities of cellulose,

FIG. 5b is an XRD analysis of calcined MgCO₃ pellets formed with varying quantities of cellulose after adsorption of phosphates.

FIG. 6 is a graph of the adsorption capacity of example MgCO₃ pellets formed with varying quantities of cellulose.

FIG. 7 is a graph of BET surface area of example MgCO₃ pellets formed with varying quantities of cellulose.

FIG. 8 is a graph of the thermal stability of MgCO₃ pellets formed with varying quantities of cellulose.

FIG. 9 is a graph of the free phosphate concentration of a phosphate-water solution over time in the presence of MgCO₃ pellets formed with varying quantities of cellulose.

FIG. 10 is a graph of phosphate concentration change over time normalized by initial concentration.

FIG. 11 depicts an embodiment utilizing metal carbonate pellets as media within a porous boom suspended in flowing water with a cutaway view of a boom.

FIG. 12 depicts a cross-sectional view of a porous boom for suspension in water filled with a metal carbonate aggregate and encased in an open foam housing.

FIG. 13 is a cross-sectional view of a wastewater pipe with a metal carbonate liner.

FIG. 14 is schematic view of a column packed with metal carbonate aggregate through which wastewater is pumped.

FIG. 15a depicts the thermal stability of porous pellets formed from MgCO₃.

FIG. 15b depicts the thermal stability of porous pellets formed from 90% activated alumina and 10% MgCO₃.

FIG. 16 depicts the adsorptive capacity of porous pellets formed from 90% activated alumina and 10% MgCO₃.

### DETAILED DESCRIPTION OF VARIOUS EMBODIMENTS

The present application is directed to materials and methods for the manufacture and use of porous structures made of a mixture of activated alumina and metal carbonates to act as phosphate and ammonia adsorbing substrates in aqueous media. High surface area structures are formed which possess nanopores, i.e., having pore radii of less than or equal to 1 nanometer (10 Å), to increase water permeability and the surface area of the substrate available for loading.

Alkaline earth metal carbonates such as MgCO₃ and lanthanoid carbonates such as La₂(CO₃)₃ have been determined to be useful metal carbonates. Strontium carbonate and zinc carbonate also possess similar characteristics for use as adsorbents. MgCO₃ is a preferred metal carbonate to act as a phosphate adsorbent because of its tendency to form magnesium ammonium phosphate (NH₄MgPO₄·6H₂O), i.e., struvite, in aqueous media having phosphate ions and ammonia, and forms magnesium phosphate pentahydrate (Mg(PO₃OH)·3H₂O), i.e. newberyite, in aqueous media having phosphate ions but little to no ammonia. The formation of NH₄MgPO₄·6H₂O (struvite) and/or Mg(PO₃OH)₃H₂O (newberyite) binds phosphate ions to MgCO₃ in the molar ratio of 1:1 and binds ammonia to struvite in the molar ratio of 1:1. This results in significant phosphate and ammonia loading onto a MgCO₃ substrate. Solid structures are preferred because they are more easily removed from an aqueous media than powders, but surface area and loading capacity per gram must necessarily be sacrificed to produce structures that can easily be manipulated and retrieved. In the following Example 1, of adsorbed PO4 and NH4 was determined using powdered MgCO3 as a control in comparison to a MgCO₃ pellet to ascertain the molar ratio of the adsorbates.

Activated alumina (Al₂O₃) is a type of porous, solid form of aluminum oxide. The term activated refers to the process that the alumina gas undergone to create a porous structure which increases its surface area, which makes it particularly good at adsorbing substances. Activated alumina is chemically inert and resistant to thermal shock, which makes it suitable for various industrial applications. Activated alumina is produced by the dehydration of aluminum hydroxide (Al(OH)₃) at high temperatures. This results in a highly porous material with a high surface area—typically around 200 m²/g. Activated alumina can adsorb both phosphates and ammonia. The adsorption process of activated alumina generally relies on physical and chemical interactions between the substance to be adsorbed (in this case, phosphates and ammonia) and the activated alumina itself.

### Phosphate Adsorption.

The surface of activated alumina carries a positive charge under certain conditions (specifically, at pH levels below 8.5). Phosphates, which carry a negative charge, are attracted to the surface of the alumina due to this charge difference. This attraction allows the alumina to adsorb the phosphate ions from the solution. This process is often called ion exchange or chemisorption.

### Ammonia.

Adsorption of ammonia by activated alumina generally occurs via physisorption, which is a physical process. This is mainly due to the weak van der Waals forces between the activated alumina and the ammonia molecules. The highly porous structure of activated alumina increases the surface area, enhancing the opportunities for these weak interactions to occur and thus increasing the adsorption of ammonia. In some cases, activated alumina may be impregnated with certain chemicals (like sulfuric acid) to enhance its ability to adsorb ammonia through chemisorption.

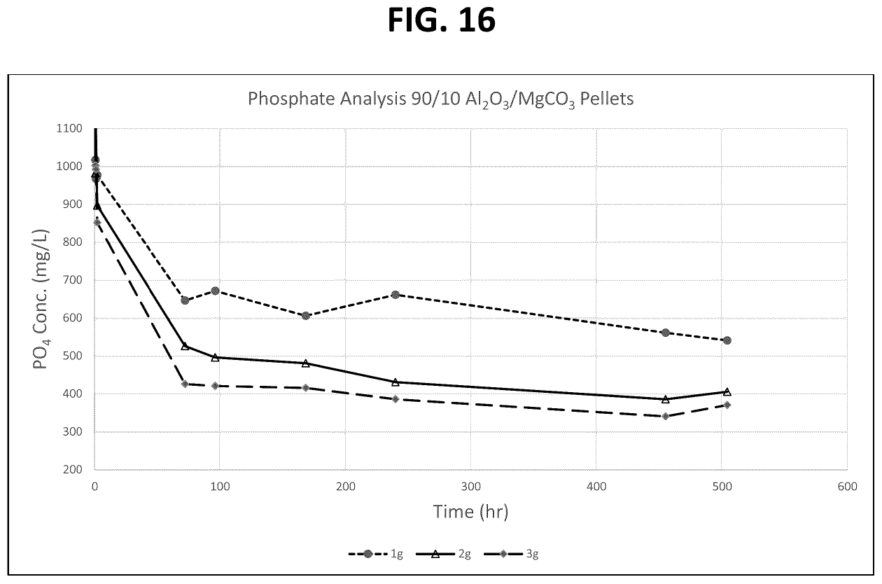

The adsorption efficiency of activated alumina for both phosphates and ammonia can be affected by various factors, including the pH of the solution, temperature, contact time, and the concentration of the substances. Therefore, these conditions need to be optimized for effective removal. As shown in FIG. 16, a useful embodiment of a phosphate adsorbing aggregate having excellent structural integrity and good phosphate adsorbing capacity is comprised of approximately 90% activated alumina and 10% MgCO₃. Aggregates comprised of less activated alumina, e.g., 50% or more and 75% or more, have less structural integrity was better phosphate adsorption.

Sample preparation of a metal carbonate used to evaluate adsorption:
i. Prepared 1000 ml of 4000 ppm PO₄³⁻ solution using NaH₂PO₄2H₂O (A herein).
   Mixed 6.57 g of A with 1 L of water:

$$6.57 g A \times \frac{94.971 g {PO}_{4}}{156.01 g A} \times \frac{1}{1000 L} = 4. g {PO}_{4} / L ( = 4100 ppm )$$

ii. Obtained 0.3228 g of sample (MgCO₃).
iii. Measured 0.597 ml of 28% NH₄OH solution in water.

$$0.597 ml \times \frac{28}{100} = 0.167 ml {NH}_{4} OH$$

Density: 0.880 g/mL

$$So , 0.167 ml {NH}_{4} OH \frac{0.88 g}{ml} = 0.147 g {NH}_{4} OH \\ 0.147 g {NH}_{4} OH \frac{18.039 g {NH}_{4}}{35.04 g {NH}_{4} OH} = 0.0759 g {NH}_{4} \\ 0.0759 g {NH}_{4} \frac{1 mol}{18.039 g} = 0.00421 mol {NH}_{4}$$

iv. Combined 100 ml of PO4 solution (in i), 1.0 g MgCO₃ sample (in ii), and 1.85 ml NH₄OH solution (in iii).
   PO4:

$$100 mL {PO}_{4}^{3 -} \frac{4000 mg}{1000 mL} \frac{1 mol}{94.971 g} = 0.00421 mol {PO}_{4}^{3 -}$$

### MgCO₃:

$$0.3228 g {MgCO}_{3} \times \frac{1 mol}{84.3139 g} = 0.00383 mol {MgCO}_{3} \\ ( 1. g {MgCO}_{3} \times \frac{1 mol}{84.3139 g} = 0.01186 mol {MgCO}_{3} )$$

### NH₄:

v. Measured PO₄³⁻ concentration using DR1900 (max 2 ppm).
   1. In order to measure PO₄³⁻ using DR1900, one needs to dilute the solution down to 2 ppm (from 4000 ppm initial concentration) in 10

$$0.597 \times \frac{28}{100} ml {NH}_{4} OH \times \frac{0.88 g}{ml} \frac{18.039 g {NH}_{4}^{-}}{35.04 g {NH}_{4} {OH}_{4}} \frac{1 mol}{18.039 g} = 0.042 mol {NH}_{4}^{-} ml absorption bottle .$$

2. Mixed 10 ml DI water with 0.005 mL solution, then measure.

### EXAMPLE 1

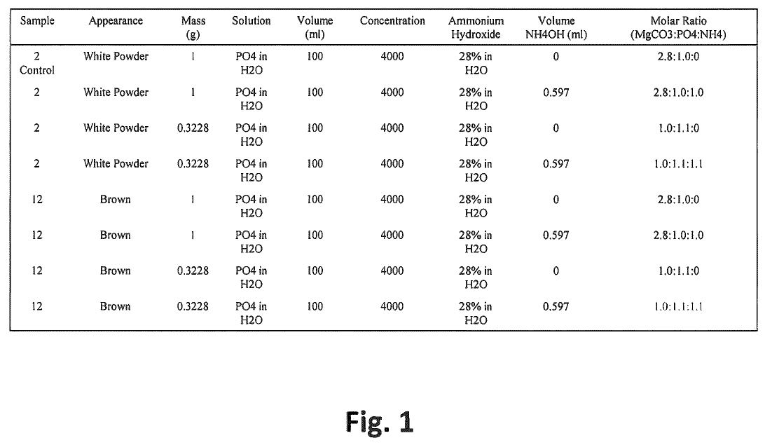

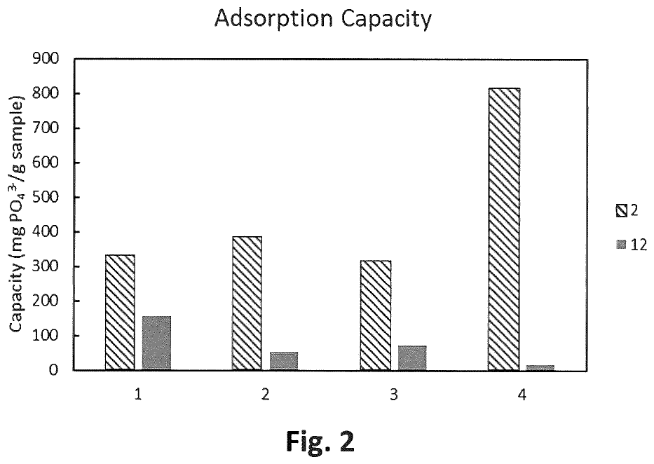

FIG. 1 summarizes the resulting molar ratios achieved with various samples. In Example 1, the adsorption capacity, FIG. 2, was measured for samples under the following conditions:
Condition 1: 1.0 g sample in 100 ml of 4000 ppm PO₄³⁻+0.0 ml NH₄OH (MgCO₃:PO₄:NH₄=2.8:1:0)
Condition 2: 1.0 g sample in 100 ml of 4000 ppm PO₄³⁻+0.6 ml NH₄OH (2.8:1:1)
Condition 3: 0.323 g sample in 100 ml of 4000 ppm PO₄³⁻+0.0 ml NH₄OH (1:1.1:0.0)
Condition 4: 0.323 g sample in 100 ml of 4000 ppm PO₄³⁻+0.6 ml NH₄OH (1:1.1:1.1)
   The results demonstrated that, in the absence of NH₄, #2 shows higher adsorption capacity (Q_{PO4}) than sample 12. In the presence of NH₄, Q_{PO4,#2} increases, while Q_{PO4,#12} decreases.

The adsorption capacity of several example samples was determined as shown in Table 1. Table 2 details the experimental conditions for each sample. Table 3 details the measured decrease of PO₄³⁻ in an aqueous solution over time for the samples of Example 1.

TABLE 1
Adsorptive Capacity

| Sample | Capacity† |
|---|---|
| A | 324 |
| B | 388 |
| C | 318 |
| D | 818 |
| E | 157 |
| F | 54 |
| G | 73 |
| H | 19 |

†Capacity (qe) = (co − cf)*V/m

TABLE 3
Concentration of PO₄³⁻ in solution containing
various MGCO₃ samples

| | Time (hrs) | | | | |
|---|---|---|---|---|---|
| Sample | 0 | 1 | 2 | 3 | 24 |
| A | 1.965 | 1.26 | 0.065 | 0.88 | 0.34 |
| B | 1.965 | 0.035 | 0.025 | 0.04 | 0.02 |
| C | 1.965 | 1.865 | 1.665 | 1.635 | 1.453 |
| D | 1.965 | 0.985 | 0.71 | 0.785 | 0.645 |
| E | 1.965 | 1.115 | 1.885 | 1.305 | 1.165 |
| F | 1.965 | 1.855 | 1.765 | 1.825 | 1.69 |
| G | 1.965 | 1.955 | 1.405 | 1.76 | 1.85 |
| H | 1.965 | 2 | 1.805 | 1.855 | 1.935 |

### EXAMPLE 2

In a further example, the adsorptive capacity in terms of the molar ratio of MgCO₃:PO₄³⁻:NH₄ is examined in baked and unbaked pellets. Samples, as summarized in Table 4, of MgCO₃ powder (control) were compared against calcined and uncalcined MgCO₃ pellets formed with cellulose as a binder. These samples were further compared against pieces of naturally occurring magnesium chalk (sample 13). All samples were immersed in 100 ml of a 4000 ppm aqueous PO₄³⁻ solution. All samples had a mass of 0.3277 g. The adsorptive capacity of the samples of Example 2 are described in Table 5.

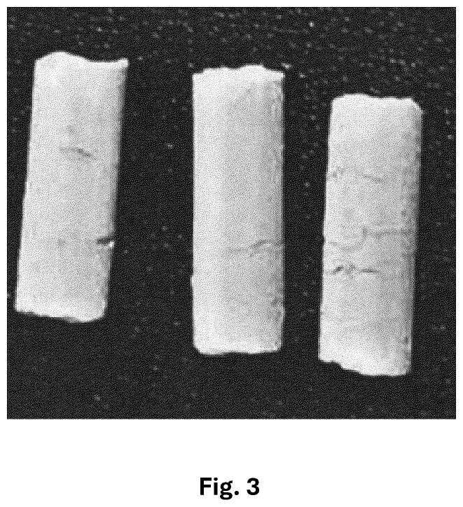

To partially compensate for the loss of available surface area for adsorption, these structures, as shown in FIG. 3 as pelletized embodiments, are formed in such a way as to increase porosity and thus increase the available surface area for adsorption. Surface area is further enhanced by increasing the density of smaller pores (e.g., nanopores) relative to the density of larger pores (e.g., micropores) in the structure. The smaller pore diameters permit a greater number of pores per given volume and thus results in an increase in available surface area for adsorption. The smaller pores also enhance structural integrity by minimally impacting the supporting framework of the structure.

TABLE 4
Example 2 Sample Characteristics

| Sample | NH4 | Molar ratio |
|---|---|---|
| 2 | 0.597 ml | 1.1:1.0:1.1 |
| 2 | 0 | 1.1:1.0:0.0 |
| 12-baked | 0.597 ml | 1.1:1.0:1.1 |
| 12-unbaked | 0.597 ml | 1.1:1.0:1.1 |
| 12-baked | 0 | 1.1:1.0:0.0 |
| 13 | 0.597 ml | 1.1:1.0:1.1 |
| 13 | 0 | 1.1:1.0:0.0 |

TABLE 5
Example 2 Sample PO₄³⁻Adsorptive Capacity

| Code | Sample # | NH4 | Molar ratio | Capacity † |
|---|---|---|---|---|
| A | 2 | 0.597 ml | 1.1:1.0:1.1 | 864 |
| B | 13 | 0.597 ml | 1.1:1.0:1.1 | 579 |
| C | 13 | 0 | 1.1:1.0:0.0 | 182 |
| D | 2 | 0 | 1.1:1.0:0.0 | 260 |
| E | 12 baked @ | 0.597 ml | 1.1:1.0:1.1 | 131 |
| | 400 C. (1~1.5 hr) | | | |
| F | 12 unbaked | 0.597 ml | 1.1:1.0:1.1 | 178 |
| G | 12 baked @ | 0 | 1.1:1.0:0.0 | 439 |
| | 400 C. (1~1.5 hr) | | | |
| H | 12 baked at | 0.597 ml | 1.1:1.0:1.1 | 361 |
| | 500 C. (1~1.5 hr) | | | |

† PO₄³⁻ (mg) adsorbed/MgCO₃ (g)

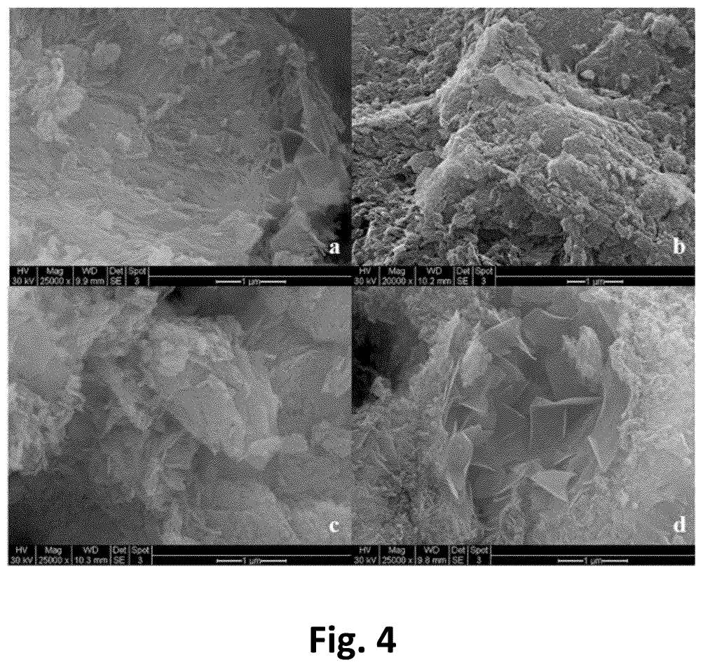

As shown in FIGS. 4a and 4b, the structure composition was examined using SEM-EDS performing both a line scan and cross-section scan of the pellet from each batch. The uniformity was determined by comparing the percentage of carbon (C), oxygen (O) and Mg present across each scan. The BET surface area was determined using a NOVA 2000e Surface Area & Pore Size Analyzer. Samples were first purged with nitrogen gas at 150° C. overnight before analysis. The surface morphology of the MgCO₃ structures was observed using SEM at an accelerating voltage of 30 kV. The crystal structure was determined using XRD with the 2-theta diffractometer under CuKα radiation and a wavelength of 1.54 μm. The XRD patterns were analyzed using JADE software.

FIG. 4c shows SEM images of the surface of (a) a calcined pelleted formed with no cellulose before phosphate adsorption, (b) a calcined pelleted formed with no cellulose after phosphate adsorption, (c) a calcined pelleted formed from a 10% cellulose-MgCO₃ mixture before phosphate adsorption, and (d) a calcined pelleted formed from a 10% cellulose-MgCO₃ mixture after phosphate adsorption. Many particulate aggregates were observed on the surface of the MgCO₃ pellets before phosphate exposure. To confirm phosphate adsorption on the surface of the pellet, the elemental composition was determined with EDS.

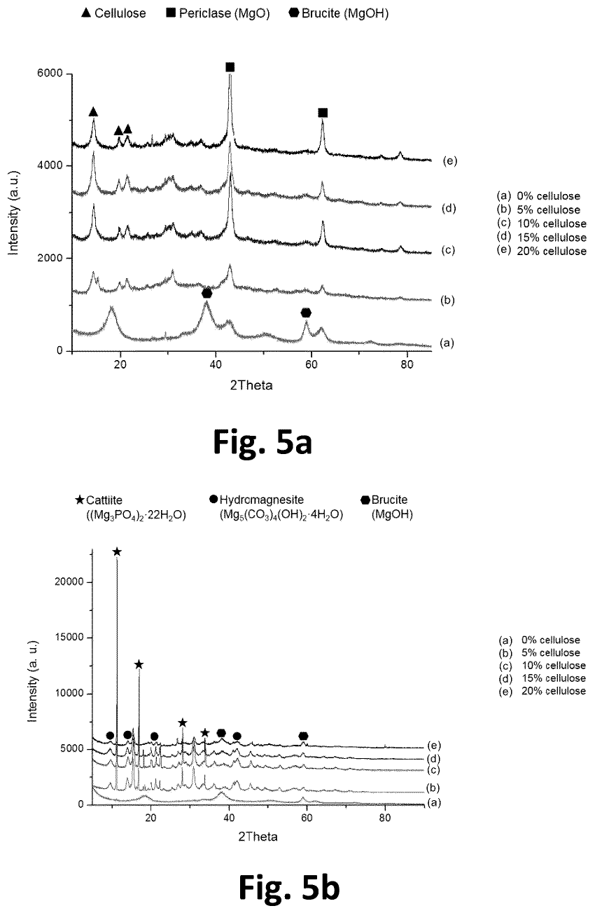

FIGS. 5a and 5b depict the XRD patterns for MgCO₃ pellets before and after an adsorption isotherm. Cellulose, periclase (MgO) and brucite (MgOH) are present in the pellets before adsorption. As shown in FIG. 5a, the pellets had both variations of magnesium present due to mixing magnesium carbonate with water and then calcining the pellets. After adsorption experiments were conducted, magnesium variations were detected mostly as hydromagnesite (Mg₅(CO₃)₄(OH)₂·4H₂O) with some remaining brucite and magnesium phosphate (as cattiite) as shown in FIG. 5b. The pellet with the most phosphate present was the 15% pellet as seen with the highest peak of cattiite. Finding magnesium phosphate after the adsorption experiments further confirmed that adsorption occurred and that the increased surface area from cellulose addition was providing additional adsorption capacity. A distinct peak was seen for phosphorus on the 10% cellulose pellet while the 0% cellulose pellet did not have such a pronounced peak, indicating that the increased cellulose content resulted in an increase in phosphate adsorption, as expected.

Various magnesium phosphates can form depending upon the pH and molar concentration and are listed below.
Monomagnesium phosphate (Mg(H₂PO₄)²)
Dimagnesium phosphate (MgHPO₄)
Magnesium phosphate tribasic (Mg₃(PO₄)²)
Amorphous magnesium phosphate.
   The XRD patterns for each sample before and after an adsorption isotherm showed that cellulose, periclase (MgO) and brucite (MgOH) were present for the pellets before adsorption. As shown in FIGS. 5a, the pellets had both variations of magnesium present due to mixing magnesium carbonate with water and then calcining the pellets. After adsorption experiments were conducted, magnesium variations were detected mostly as hydromagnesite with some remaining brucite and magnesium phosphate (as cattiite) as shown in FIG. 5b. The pellet with the most phosphate present was the 15%1 pellet as seen with the highest peak of cattiite. Finding magnesium phosphate after the adsorption experiments further confirmed that adsorption occurred and that the increased

Analytical grade MgCO₃ powder was formed into pellets, 6 mm in diameter and 17 mm in length on average in one non-limiting embodiment, using flat die pellet mill. Varying amounts of a cellulose binder having an average particle size of 20 μm was used to optimize the pellet design.

In an exemplary experiment, cellulose was added in amounts from 0 to 20% by mass to slurries comprised of 55% MgCO₃ by mass and 45% deionized water by mass. The cellulose acts as a binder which can be removed by calcination. Polyvinyl alcohol or similar organic polymers are also useful for this purpose.

After shaping, the pellet structures, in an embodiment, are calcined at 300° C. to remove the cellulose for additional porosity without impacting the integrity of the magnesium carbonate structure. Cellulose content and calcination time were varied to evaluate the effect of these variables as follows: 0% cellulose calcined for 17 hours (0%17), 5% cellulose calcined for 1 hour (5%1), 10% cellulose calcined for 2 hours (10%2), 15% cellulose calcined for 1 hour (15%1) and 20% cellulose calcined for 2 hours (20%2). Small pellet structures, e.g., cylindrical pellets having a diameter of approximately 10 mm or less, were also successfully formed from MgCO₃ without the need for a binder provided that the pellet can be formed without sacrificing too much surface area provided by the pore volume. In an embodiment, a slurry pre-mix is created mixing powdered metal carbonates with or without a binder.

The slurry pre-mix is diluted in deionized water or a similar diluent that can be volatilized and mixed to form a slurry. The slurry is then dried and subsequently ground into a powder. The carbonate-diluent mixture, or the carbonate-diluent-binder mixture are then pressed into a desired form. In an embodiment, cylindrical pellets are formed having a diameter of approximately 5 mm and a length of approximately 4 mm. Cylindrical pellets are particularly useful in that they can be packed together so as to permit maximum exposure of their outer surface which optimizes access to the pores extending through the structure so as to achieve a desired accessible active surface area for scavenging phosphates and ammonia.

When the slurry is compacted, the binder material acts to form carbonate free areas within the pre-calcined mixture. During calcination, the volatilization of the diluent and pyrolysis of any binder material in the slurry creates pores in the formed structure as the volatilized diluent and gaseous combustion by-products escape from within the pressed structure. The resulting structure possesses greater surface area and structural integrity than would otherwise be available from just a pressed powder. The pressure required to form a structure from the powdered carbonate alone would result in a lower available surface area due to the collapse of pores as the material is compressed. The formed structure is then calcined to remove the binder and any remaining diluent. Ideally, the binder is a material that can be removed through calcining while leaving little char. Cellulose is a non-limiting example of an acceptable binder material.

The mass % of cellulose as a binder in the slurry should be no more than 20%, preferably no more than 15%, and most preferably between about 95% and about 15%. Binder content is optimized to ensure that a sufficient surface area is formed from the resulting increase in porosity when the binder is removed by calcining while still achieving a desired structural integrity of the resulting structure that could otherwise be compromised from making the structure too porous. If the structural integrity is insufficient, the pores will collapse and reduce the surface area available for adsorbing phosphates and ammonia. This is problematic in shipping such structures, especially pellets, as the surfaces and structures at the bottom of a shipment can exhibit structural failure in storage and transport, thus leading to waste.

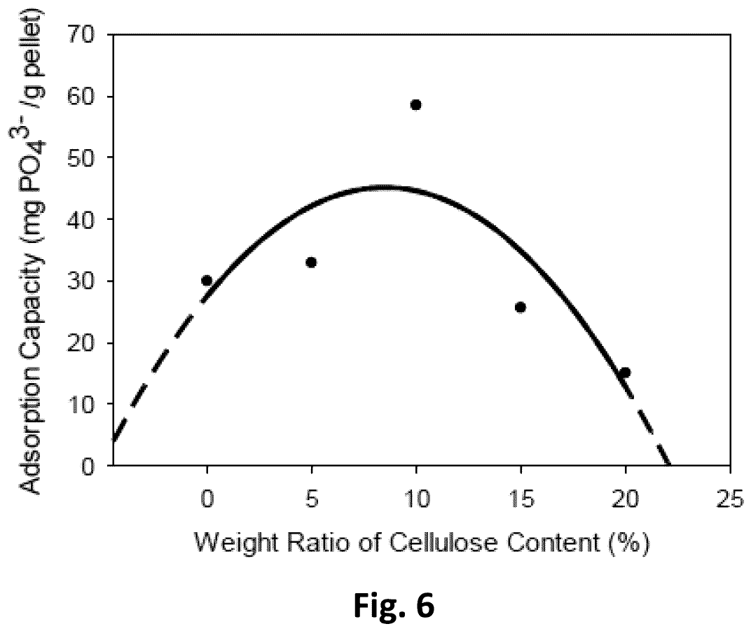

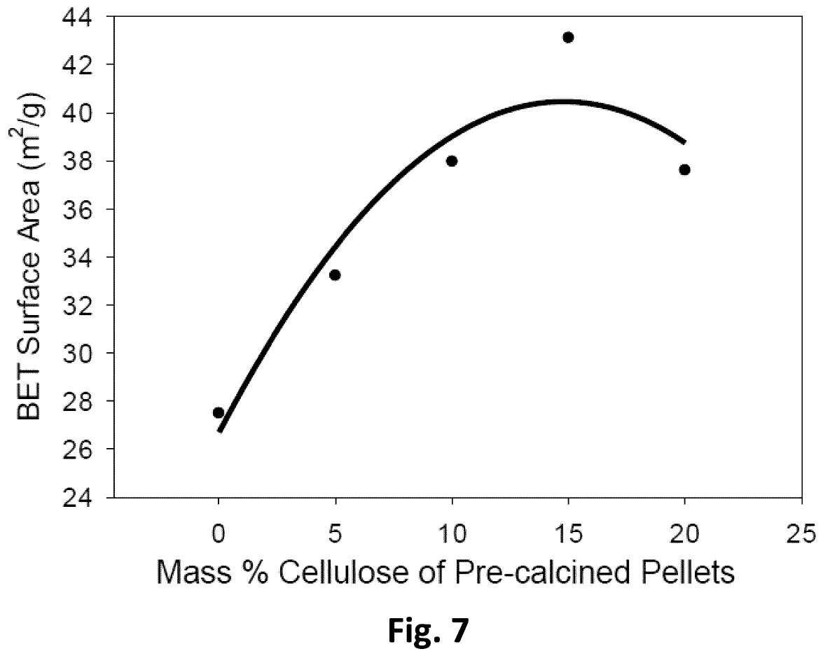

In experiments, it was generally found that pellets of MgCO₃ formed from a slurry pre-mix equal to approximately 20% cellulose by mass lacked sufficient structural integrity to maintain a useful pore volume. FIG. 6 reveals a MgCO₃-cellulose ratio curve generated from experimental data using a cylindrical 6 mm×17 mm pellet with the capacity dropping significantly as 20% cellulose was reached. The 20% cellulose pellet also appeared to be structurally unstable in water, so no higher cellulose ratio was studied. FIG. 7 depicts the relationship between pre-calcined pellet cellulose content and calcined BET surface area.

Calcining times vary by binder material, structure size, and mass percent of binder and diluent. The cellulose in the aforementioned pellets can be calcined from the resulting slurry at temperatures at or above 200° C., more preferably at a temperature at or above 300° C., and most preferably at a temperature at or above 350° C. Smaller structures such as the aforementioned pellet formed with cellulose as a binder, for example, should be thoroughly calcined for 1 to 2 hours at the previously suggested temperatures. In an embodiment, the aforementioned pellets are calcined at a temperature of 300° C. throughout the structure for 2 hours. After 2 hours, enough cellulose has undergone pyrolysis to form a pellet having a porosity of approximately 70% to 80%. After approximately 80% porosity, the pellet will lose structural integrity and will be unable to maintain a preferred pore volume. As the cellulose undergoes pyrolysis, gaseous by-products form within the slurry and escape, leaving open pores. Ideally, the binder is selected and calcined so as to minimize the production of char or other combustion by-products that could block pores and reduce the available surface area for adsorption.

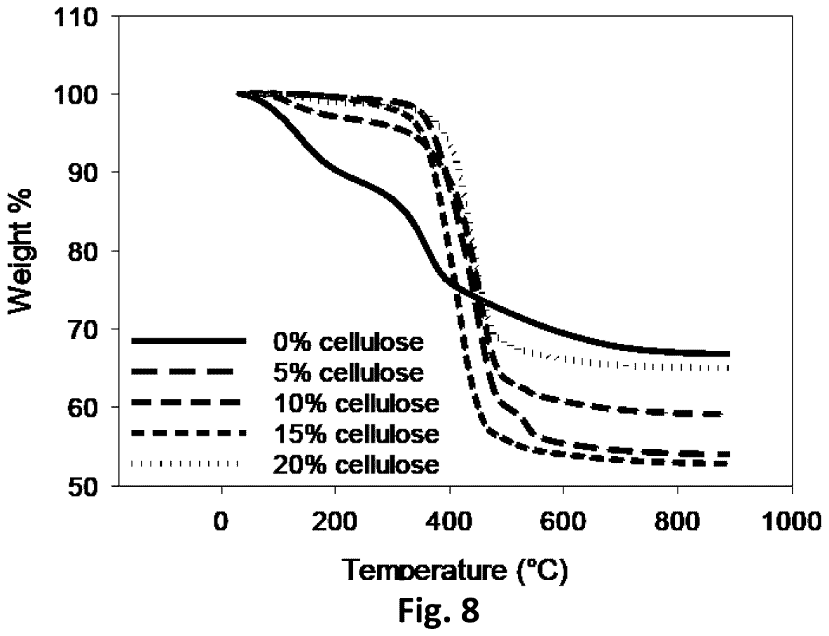

FIG. 8 demonstrates the thermal stability of the aforementioned experimental MgCO₃ pellets. The pellet formed with 0% cellulose had a peak for onset degradation temperature at 319° C. and is the baseline. The pellets formed with cellulose showed improvement in onset decomposition temperature. The onset decomposition temperatures for the pellets formed with 5%, 10% 15%, and 20% cellulose were 384, 399, 364 and 403° C., respectively. The cellulose provided binding and increased the thermal stability until a cellulose content of 15% was utilized and the increase in porosity slightly decreased the stability. However, the pellet formed with 15% had a higher onset degradation temperature than the pellet formed with 0% cellulose. The pellet formed with 20% cellulose showed an increase in thermal stability over the pellet formed with 15% cellulose due to char on the surface and in the pores.

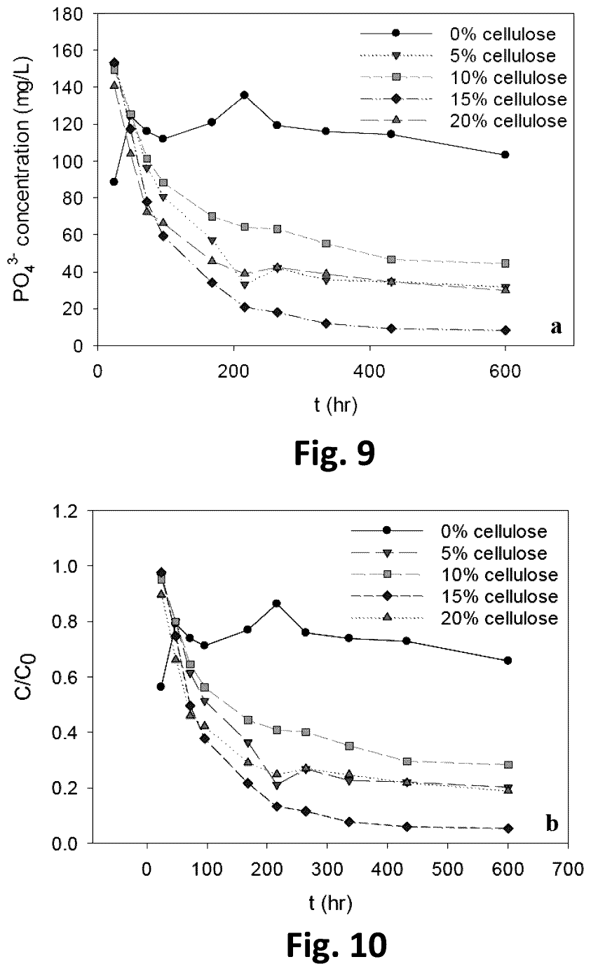

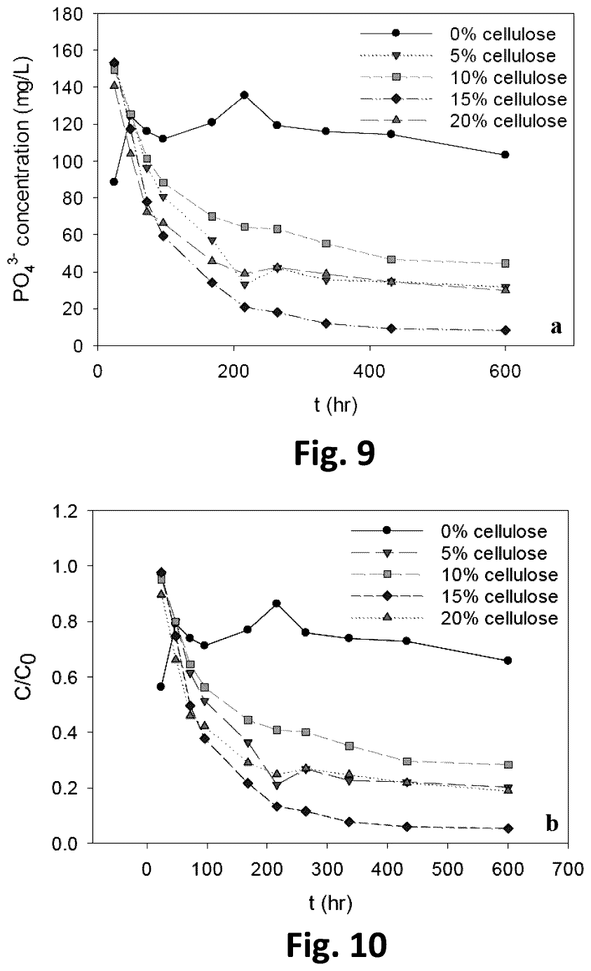

Adsorption experiments conducted on the example pellets determined the equilibrium time for the phosphate concentration remaining in the solution after pellets had reached adsorption capacity. FIG. 9 discloses how the phosphate concentration in an experimental solution changed with respect to time. FIG. 10 demonstrates how the phosphate concentration of an experimental solution changed over time when normalized by initial concentration.

### EXAMPLE 3

In a further example, a series of pellets were synthesized to so as to control the adsorption sites, morphology, sorption selectivity and strength of phosphate (PO₄³⁻) adsorption. To enhance PO₄³⁻ selectivity, a range of mechanically stable pellets were prepared by blending different ratios of magnesium carbonate and alumina to optimize the pellet design and generate a more cost-effective adsorbent. Alumina was added in varying weight ratios from 0 to 100%. Six specific ratios were selected for the alumina ratio: 0% alumina; 30% alumina; 50% alumina; 70% alumina; 90% alumina; and 100% alumina. The pellet mill conditions were kept the same across all samples, but some variation regarding the length of the pellet still existed. The resulting sorption capacity ranged between 56 and 92 mg/g, which outperformed the capacities for the state-of-the-art and commercial phosphate adsorbents.

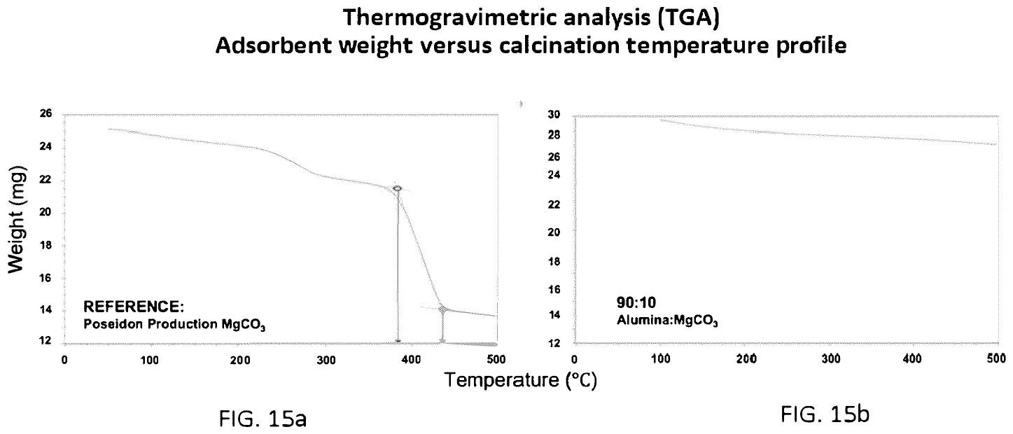

The results of thermal analysis of (A) the reference material (i.e., magnesium carbonate production scale) and (B) the blended 90:10 alumina to magnesium carbonate are shown in FIGS. 15a and 15b. An endothermic reaction occurred at a calcining temperature of approximately 100° C., which was accompanied by a significant decrease in quality, particularly for the reference material. The reference material is assumed to have undergone dissociation to release the water of crystallization at a temperature near 100° C. These results show that blended Alumina:MgCO₃ is more stable than the reference material, where the structure of the baseline has changed significantly at a temperature near 200° C. (significant decrease in mass). Above 500° C., the blended material showed a steady reduction in mass. Even though the sorption capacity of the unblended magnesium carbonate pellet was higher than that of the 90:10 alumina to magnesium carbonate—92 mg/g compared to 72 mg/g, TGA results depicted in FIGS. 15a and 15b show that the blended material had higher stability. The thermal analysis is consistent with the hardness measurements. As shown in Table 6, the blended sample (90:10) was much harder than the reference pellet, i.e., 105±59 N compared to 53.4±17.4 N. Hardness is important from an economic perspective to ensure minimal crushing and product loss is achieved in the delivery of pelletized adsorbants.

The efficiency of the phosphate removal adsorption is described in FIG. 16. Once activated alumina has adsorbed phosphates or ammonia, it will eventually become saturated. The substances adsorbed by the activated alumina can be removed through regeneration of the activated alumina.

Regeneration typically involves using heat, steam, or a chemical agent to remove the adsorbed substance from the activated alumina. The choice of regeneration method depends on the specific application and the substance to be removed. After the activated alumina has been regenerated, it can be reused. However, the efficiency of the regeneration process can depend on a variety of factors, and multiple rounds of adsorption and regeneration may gradually decrease the capacity of the activated alumina to adsorb phosphates and ammonia. As such, the alumina may eventually need to be replaced. To recover phosphates from activated alumina, an acidic wash, typically HCl, is utilized, while a caustic wash, typically NaOH, is utilized to cause the desorption of ammonia. The increased affinity of the contaminant to the wash relative to the activated alumina is believed to be the mechanism causing the desorption.

Additional benefits can be conferred by impregnating the activated alumina to improve adsorption by matching the agent to be impregnated with the selectivity desired. For example, activated alumina can be impregnated with ferric hydroxide and/or ferrous hydroxide to increase phosphate adsorption efficiency. Selective adsorption of nitrates and nitrites is also possible with the appropriate impregnated agent.

When phosphates have been adsorbed onto activated alumina, they can be removed or desorbed from the alumina through a process known as regeneration. Regeneration typically involves flushing the activated alumina with a solution that encourages the release of the adsorbed phosphate ions. This is often a high pH solution, as phosphate adsorption by activated alumina is usually optimal in acidic conditions and less so in alkaline conditions.

For instance, a sodium hydroxide (NaOH) solution, which is a strong base, could be used to increase the pH and trigger phosphate desorption. After the phosphate ions have been desorbed, they can be removed from the solution through a variety of methods, such as precipitation or further treatment.

In the case of ammonia, heat is often used for regeneration, i.e. desorption. This is known as thermal regeneration. The process typically involves raising the temperature to between 100-200° C. while passing a stream of air or an inert gas like nitrogen through the alumina. This causes the ammonia to proceed into desorption from the alumina and be carried away by the gas stream.

It's important to note that the regeneration process needs to be managed carefully. Too high a temperature can damage the activated alumina, while too low a temperature may not fully remove the adsorbed substances. After several cycles of adsorption and regeneration, the activated alumina may start to lose its effectiveness and will need to be replaced.

These substantially water-insoluble carbonate structures possess a relatively high surface area per given volume due to their porosity and work well with standing water as well as effluent streams in both uncontrolled water run-off and end-of-pipe applications in reducing the concentration of these contaminants in water and in reducing the environmental impact of human activities such as farming and mining. Circulating water across the pellets acts to increase the contact rate of a given volume of water with the substrate. The enhanced porosity of the structures greatly increases surface area through an increase in pore volume, and thus increases the residence time of contaminated water at the liquid-solid interface of the system where adsorption takes place. Additional applications for the use of these adsorbents include the removal of phosphates and ammonia from septic systems, the remediation of lakes, and the remediation of storm runoff in urban and suburban areas. Remediation of mine drainage would also be improved, especially from phosphate mining activities and where phosphate containing explosives are utilized.

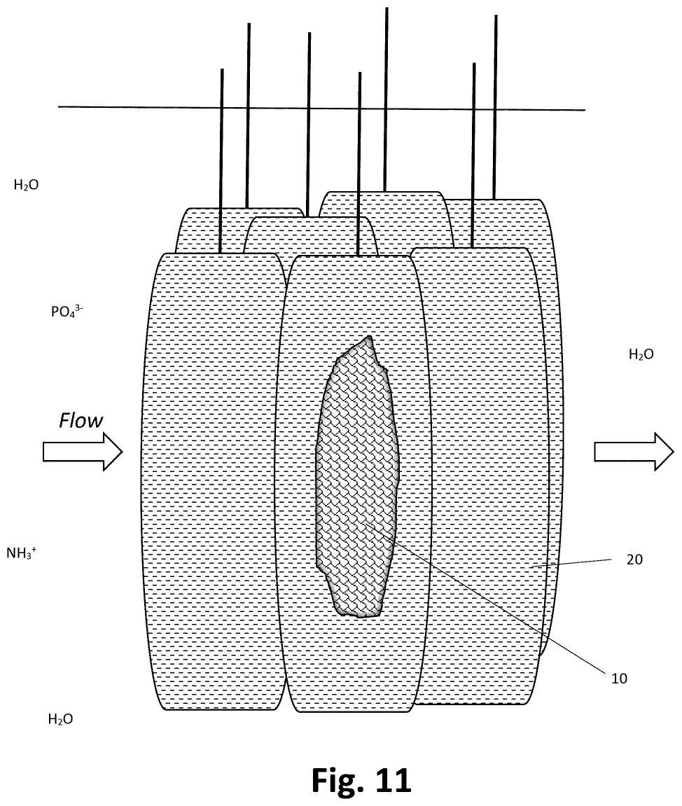

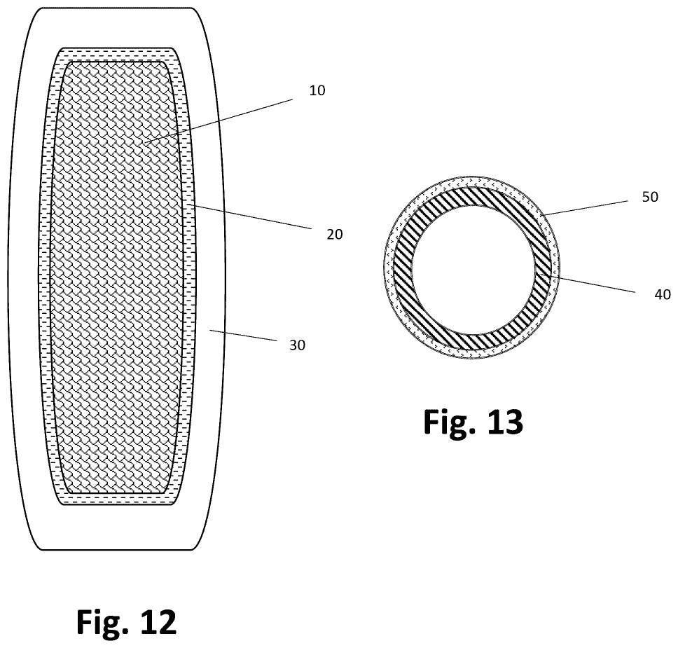

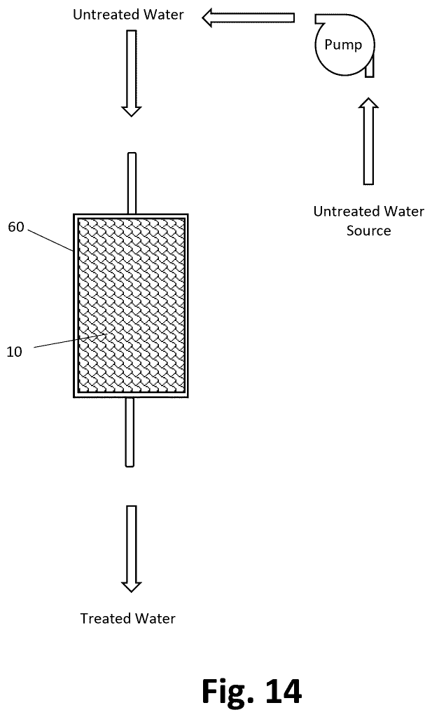

As depicted in FIG. 11, pelletized metal carbonate structures 10 can contained within a porous housing 20 and placed in water, e.g., a porous mesh or a polypropylene bag. The pelletized structure is preferably a substantially cylindrical pellet although other shapes are also useful. As shown in FIG. 12, these porous housings 20 of pellets 10 may also be placed within an open cell foam casing 30 as a barrier to common debris (e.g., leaves, wood, and insects) that could potentially interfere with the porosity of the pellet housing 20. These carbonate structures can also be formed as other structures, FIG. 13, that are intended to come into contact with wastewater, e.g., liners. In a non-limiting example, a wastewater pipe 50 may utilize a metal carbonate liner 40. As shown in FIG. 14, the metal carbonate pellets 10 may also be used as media in a flow through column 60.

As phosphates are adsorbed by the carbonate pellets, newberyite (MgHPO₄(H₂O)₃) is formed. When ammonia is also present and bound to the pellet, struvite (MgNH₄PO₄(H₂O)₆). The contaminated pellets that contain captured phosphates and/or ammonia may be ground and utilized as a slow-release fertilizer, contributing not only to the removal of phosphates from the environment through their capture from wastewater and resulting in the conservation of phosphorous as a resource. Wastewater sources that contain reclaimable phosphorus include municipal wastewater and agricultural runoff.

Desorption experiments were conducted to evaluate the potential to release the recovered phosphate. The concentration of phosphate that returned to the solution was measured and the desorption percentage of phosphate was calculated which confirmed the desirability of spent or loaded pellet for use as a slow-release fertilizer

Sample Characterization: The Brunauer, Emmett, and Teller (BET) surface area of the resulting adsorbent structure was determined using a Tristar 3000 porosimeter analyzer (Micromeritics). Prior to characterization, the samples were first outgassed by purging with nitrogen gas at 150° C. for 2 hours. The surface morphology of the various materials was characterized using an environmental scanning electron microscope. Elemental analysis of the samples was performed using Energy-dispersive X-ray spectrophotometer (EDS) installed in the ESEM. The crystal structure of the adsorbents was determined by X-ray diffraction (XRD) analysis using a 2-theta diffractometer at a wavelength of 1.54 μm and at 2-theta range 2-90° under CuK_{α} radiation. To gain further insights on the physical properties of the synthesized materials, high resolution-transmission electron microscopy (HR-TEM, model JEM-2010F, obtained from JEOL) was used with a field gun emission at 200 kV. Before analysis, the materials were dispersed by ultrasonication in 99.8% pure isopropyl alcohol for 20 min. Then, a single drop of the supernatant was fixed on a carbon-coated copper grid (LC325-Cu, EMS) and dried at room temperature prior to imaging. The obtained images were analyzed using ImageJ, an image processing software.

Adsorption Experiments: To evaluate the effectiveness of each adsorbent for the removal of phosphate, several adsorption experiments were conducted and their results compared. Variable dose isotherm experiments were conducted to determine equilibrium adsorption parameters. Varying masses of adsorbent, ranging from 0.15-1.5 g, were placed in 125 mL Nalgene polypropylene bottles with 100 mL of the phosphate stock solution. The solution was prepared by dissolving sodium phosphate monohydrate in deionized water (2 mM) with 15 mM MOPS buffer to maintain a constant pH (pH 7). The bottles were placed on a rotary shaker at 150 rpm for 2 weeks to ensure equilibrium was reached. After adsorbent saturation, samples were filtered using a 0.45 μm polypropylene syringe filter and analyzed for phosphate concentration remaining in solution.

Column tests were conducted in 80 cm height and 1.9 cm diameter Harvel plastic columns. Ten grams of adsorbent media was placed in the columns with sand and gravel above and below, as well as a stainless-steel sieve at the bottom end of the column to prevent washout. Using a peristaltic pump, the phosphate solution (at an initial phosphate concentration of 215 mg L⁻¹), was passed through the column at a rate of 2 mL min⁻¹ at room temperature Similar to the isotherm experiment, solution pH was adjusted initially and buffered to remain constant. The column effluent samples were collected, filtered using a 0.45 μm polypropylene syringe filter, and analyzed for phosphate concentration at various time periods. All isotherm and column experiments were conducted once, and sample measurements were analyzed in triplicate and averaged.

The phosphate concentration in all experiments was analyzed by a colorimetric measurement technique in which ammonium molybdate and potassium antimony tartrate react in an acidic solution with orthophosphate to form phosphomopydbic acid which can be reduced by ascorbic acid to form an intense blue color. The absorbance due to the blue complex was monitored at 880 nm using a UV-Vis spectrophotometry. This is based off the US EPA Method 365.1 for the determination of dissolved orthophosphate.

The BET surface area for each adsorbent was measured prior to and after phosphate adsorption, as illustrated in Table 2. The adsorbent with the highest BET surface area was the MgCO₃ pellet, which had a surface area of roughly 26 m²g⁻¹ prior to phosphate adsorption, while the other adsorbents had much lower surface areas of about 2 m²g⁻¹. Since adsorption is a surface-based process, higher surface areas should correlate to an increased adsorption capacity as there are an increased number of sites for the phosphate ions to adhere to the sorbent surface. Upon comparison of BET surface areas prior to and after phosphate adsorption, the used samples were found to have higher surface areas. This increase in surface area after adsorption indicates that the phosphate is adsorbed onto the material surface, forming a surface complexation, thus resulting in an increased surface area when compared to the unused sorbents.

SEM was conducted to evaluate the surface morphology of the different adsorbents before and after PO₄³⁻ adsorption as illustrated in FIG. 1. The different adsorbents yielded quite different surface morphologies, which may play a significant role in overall phosphate adsorption. For the CaCO₃ sample, seen in FIGS. 1 (a) and (b), the surface structure appears to form as a bulky, irregular crystal with particles ranging from nano- to micron-sized. The La₂(CO₃)₃ sample, illustrated in FIG. 1 (d), revealed the formation of aggregates ranging from 0.5 to 2.0 μm after PO₄⁻³ adsorption compared to the pellet before adsorption as seen in FIG. 1 (c). FIG. 1 (f) shows SEM images for the MgCO₃ adsorbent. This material had a sheet like structure, similar in appearance to the mineral selenite rose, with amorphous “sheets” averaging 2 μm in length.

FIG. 2 shows XRD patterns of MgCO₃, CaCO₃, and La₂(CO₃)₃ samples. The peaks of XRD spectra were identified using JADE software (MDI, Inc., Livermore, CA) with JCPDS 04-013-7631 for hydromagnesite (Mg₅(CO₃)₄(OH)₂(H₂O)₄), 04-009-5447 for magnesium oxide (MgO), 04-010-3609 for lanthanite (La₂(CO₃)₃(H₂O)₈), 01-080-9776 for calcium carbonate (CaCO₃) and 00-036-0426 for dolomite (CaMg(CO₃)₂). As seen in FIG. 2 (a), raw MgCO₃ powder was already converted into hydromagnesite due to humidity in the air. It was partially converted into MgO during the heat treatment with cellulose for the pellet preparation. MgO was converted into hydromagnesite again during PO₄³⁻ removal processes. Unfortunately, the formation of newberyite (MgHPO₄(H₂O)₃) was not observed, which may be due to concentrations below the detection limit. This may indicate that PO₄³⁻ adsorption occurs on the surface of pellets since the presence of phosphorus was detected by EDS analysis (see Figure S1). For lanthanum pellets, lanthanite (La₂(CO₃)₃(H₂O)₈) was observed in raw La2(CO3)3 powders due to humidity in the air. However, lanthanite peaks were not detected in the sample calcined with cellulose but lanthanum remained as seen in FIG. S1. Again, lanthanite formed after PO₄³⁻ adsorption. A similar phenomenon was observed in the MgCO₃ samples where no peaks corresponding to phosphorus containing lanthanum were detected. This may also be due to the surface-limited reaction for PO₄³⁻ adsorption. In this case, although the peak corresponding to phosphorus was detected in EDS analysis, the concentration of phosphorus could not be determined because of lower concentration of phosphorus on the surface of La₂(CO₃)₃ pellets as well as a masking effect due to gold coating for SEM analysis (see FIG. S1). For CaCO₃ pellets, two compounds, CaCO₃ and CaMg(CO₃)₂, were detected and these phases did not change during the entire preparation and treatment processes. This indicates CaCO₃ samples are very stable in water. Interestingly, no phosphorus containing forms in all three pellets were detected with XRD analysis. As discussed before, this is likely due to the surface-limited reaction for PO₄³⁻ adsorption and EDS analysis supported the findings.

FIG. 3 shows HR-TEM images of each sample. As seen in FIG. 3 (a), the measured lattice spacing in the MgCO₃ pellets before PO₄³⁻ adsorption were 0.270 and 0.211 nm, corresponding to (321) plane of Mg₅(CO₃)₄(OH)₂(H₂O)₄ and (400) plane of MgO, respectively. After PO₄³⁻ adsorption, the lattice spacing of 0.230 nm, which corresponds to (400) plane of Mg₅(CO₃)₄(OH)₂(H₂O)₄, was measured (see FIG. 3 (b)). These results were in good agreement with the results of XRD analysis showing the presence of both hydromagnesite and magnesium oxide in the pellet before adsorption process and MgO was converted into hydromagnesite after PO₄³⁻ adsorption. As seen in FIGS. 3 (c) and (d), the measured lattice spacing of 0.272 and 0.301 nm corresponding to (016) and (115) planes of La₂(CO₃)₃(H₂O)₈, respectively, indicated the presence of lanthanum carbonate in the pellets even though the XRD patterns were not clear after the pellet preparation using cellulose. For CaCO₃ pellets, lattice spacings of 0.303 and 0.153 nm were observed, which correspond to the (104) plane of CaCO₃ and (122) plane of CaMg(CO₃)₂, respectively. These results are also in good agreement with the XRD results. Unfortunately, no lattice spacing corresponding to phosphorus-containing compounds was observed in the analyzed area of each sample after PO₄³⁻ adsorption since a very limited area can be shown with HR-TEM analysis at very high magnification of 800,000.

### Adsorption Results

The specific relationship between the equilibrium adsorbate concentration in solution and the amount adsorbed at the surface can be revealed by adsorption isotherms. The isotherm results for phosphate adsorption onto the La—, Ca—, and Mg—CO₃-based sorbents at a constant temperature of 21° C. were analyzed using the Langmuir and Freundlich isotherm models. The Langmuir adsorption equation is based on the assumptions that: (1) adsorption is limited to one monolayer, (2) all surface sites are equivalent (i.e. free of defects), and (3) adsorption to one site is independent of adjacent sites occupancy condition ^{[361]}. The Langmuir isotherm is expressed as:

$${q}_{e} = \frac{{q}_{max} {K}_{L} {C}_{e}}{1 + {K}_{L} {C}_{e}}$$

where qₑ is the amount of adsorbate adsorbed per unit mass of adsorbent (mg/g), Cₑ is the amount of unadsorbed adsorbate concentration in solution at equilibrium (mg/L), qₘₐₓ is the maximum amount of adsorbate per unit mass of adsorbent to form a complete monolayer on the surface (mg/g), and K_{L} is a constant related to the affinity of the binding sites (L/mg). In its linear form, the Langmuir equation can be expressed as:

$$\frac{{C}_{e}}{{q}_{e}} = \frac{1}{{q}_{max}} {C}_{e} + \frac{1}{{K}_{L} {q}_{max}}$$

A linear plot of specific adsorption against equilibrium concentration ((Cₑ/qₑ) vs. Cₑ) as seen in FIG. 4 indicates that phosphate adsorption onto the La—, Ca—, and Mg-CO₃-based adsorbents obeys the Langmuir model. The Langmuir constants qₘₐₓ and K_{L}, determined from the slope and intercept of the plot, are presented in Table 2. While the LaCO₃ and MgCO₃-based adsorbents had similar monolayer phosphate adsorption capacities (49.5 and 52.6 mg/g, respectively), the CaCO₃-based adsorbent had a much lower capacity for phosphate adsorption (18.7 mg/g). The dimensionless constant separation factor R_{L} ^{[}38] can be used to express essential characteristics of the Langmuir isotherm according to the following equation:

$${R}_{L} = \frac{1}{1 + {K}_{L} {C}_{0}}$$

where C₀ is the initial adsorbate concentration (mg/L) and K_{L} is the Langmuir constant (L/mg). Values of R_{L} can indicate the favorability of adsorption; that is, for favorable adsorption, 0<R_{L}<1; for unfavorable adsorption, R_{L}>1; R_{L}=1 for linear sorption; and for irreversible adsorption, R_{L}=0 ^{[35]}. Values of R_{L}, documented in Table 2, were in the range of 0-1, suggesting favorable adsorption of phosphate onto the La—, Ca—, and Mg—CO₃-based adsorbents.

The Freundlich isotherm, applicable for non-ideal adsorption on heterogeneous surfaces with multi-layer sorption, is expressed as:

qₑ=K_{F}Cₑ^{1/n}

where K_{F} is the adsorption capacity of the adsorbent (mg/g (L/mg)^{1/n}) and n indicates sorption favorability, with values of n in the range 1<n<10 indicating favorable sorption. As values of n approach 1, the impact of surface heterogeneity can be assumed less significant and as n approaches 10, surface heterogeneity becomes more significant. Typically, adsorption capacity of an adsorbent increases as the values of K_{F} increase. The Freundlich constants K_{F} and n can be determined by the linearized form of the Freundlich equation:

$$log {q}_{e} = log {K}_{F} + \frac{1}{n} log {C}_{e}$$

The linear plot of the Freundlich isotherm for phosphate adsorption onto phosphate the La, C—, and Mg—CO₃-based adsorbents is shown in FIG. 5. The Freundlich constants were determined from the slope and intercept of the plot and are documented in Table 2.

Isotherm results best followed the Langmuir model, which assumes the formation of a monolayer of adsorbate on the adsorbent. According to the Langmuir isotherm, the Mg—CO₃-based adsorbent proved to have the highest adsorption capacity, followed by the La—CO₃-based adsorbent while the Ca—CO₃-based adsorbent was not as effective at removing phosphate. The increased phosphate removal for the MgCO₃ material is likely due to its increased BET surface area.

Column experiments were conducted to evaluate the phosphate adsorption as would be seen in an industrial-scale fixed bed adsorber. The breakthrough curves were constructed by plotting the ratio of PO₄³⁻ concentration at time t to the initial influent concentration (C/C₀) versus time (t). FIG. 6 shows the typical “S” shape of the breakthrough curves indicating the effects of mass transfer parameters as well as internal resistance within the column. Phosphate adsorption was initially high, decreasing with time until fully saturated. Breakthrough for LaCO₃ and CaCO₃ occurred at 30 min while, for MgCO₃, the time to reach breakthrough was 1 hr. Yet, after 7 hr of operation, the CaCO₃ adsorbent was 95% saturated while LaCO₃ and MgCO₃ were only 73 and 74% saturated, respectively. Though the time to reach breakthrough was twice as long for the MgCO₃ sorbent compared to the LaCO₃ sorbent, the LaCO₃ sorbent proved to have the greatest phosphate column capacity as well as having a longer operation time to reach 95% saturation (36 hr compared to 30 hr), indicating that the LaCO₃ adsorbent was the best sorbent for phosphate adsorption in continuous column experiments.

The cumulative adsorption capacity of the columns for phosphate adsorption was determined and illustrated in Table 3. Cumulative column adsorption capacity for LaCO₃, CaCO₃, and MgCO₃ was 20.1, 13.0, and 17.8 mg/g, respectively. These results show that the phosphate adsorbent capacity of the adsorbents in columns were lower when compared to batch experiments. However, the adsorbent mass differed between experiments and this is the likely reason for differing values of adsorbent capacity. Also, batch experiments were conducted using 0.1 L of phosphate solution while the continuous column experiments passed around 5.0 L of phosphate solution through the sorbents. The adsorption capacity of the activated aluminum pellets described herein ranges from 81 to 500 mg/g depending upon the length of the time and phosphate concentration.

The aforementioned embodiments are non-exclusive and are intended to be non-limiting. It is envisioned that one skilled in the art could create additional embodiments based solely upon this disclosure with little to no experimentation where such embodiments provide expected results.

What is claimed is:

1. A water contaminant adsorbing structure comprising a water-permeable aggregate of activated alumina and a substantially water insoluble metal carbonate substrate formed into a user desired shape, wherein said substrate adsorbs at least one of phosphate and ammonia, and said aggregate has nanopores and a multiBET surface area of at least 20 m²/g.

2. The structure of claim 1, wherein said aggregate is comprised of at least 50% activated alumina.

3. The structure of claim 2, wherein said aggregate is comprised of at least 75% activated alumina.

4. The structure of claim 3, wherein said aggregate is comprised of approximately 90% activated alumina.

5. The structure of claim 1, wherein said aggregate has a multiBET surface area of at least 25 m²/g.

6. The structure of claim 5, wherein said aggregate has a multiBET surface area of at least 30 m²/g.

7. The structure of claim 1, wherein said metal carbonate is at least one of magnesium carbonate and lanthanum carbonate.

8. The structure of claim 1, wherein said structure is produced by the process of:
a. creating a slurry by mixing a diluent, powdered activated alumina, at least one of a powdered metal carbonate and a binder-metal carbonate mixture;
b. forming preliminary structure by forming said slurry into a shape;
c. calcining said preliminary structure so that only said activated alumina and said metal carbonate substantially remains.

9. The structure of claim 8, wherein said slurry is formed by the process of:
a. adding 10% to 50% water by mass to said powdered activated alumina and said powdered metal carbonate to create a pre-slurry of a desired consistency;
b. partially drying said pre-slurry;
c. grinding said pre-slurry into a granular paste; and
d. shaping said structure from said granular paste.

10. The structure of claim 9, wherein said water is deionized water.

11. The structure of claim 9, wherein said binder is selected from the group consisting of cellulose and organic polymers.

12. The structure of claim 1, wherein said structure is a bed of pellets wherein each pellet is shaped as at least one of substantially cylindrical pellets and substantially spherical pellets.

13. A method of removing contaminants from water comprising placing a water-permeable, contaminant adsorbing structure having nanopores in water contaminated with at least one of phosphates and ammonia, wherein said structure is characterized by having a multiBET surface area of at least 20 m²/g and is formed from a substrate that adsorbs at least one of phosphates and ammonia, wherein said substrate is an aggregate of activated alumina and a substantially water insoluble metal carbonate.

14. The method of removing contaminants from water of claim 13, wherein said structure is selected from the group consisting of pellets, baffles, liners, screens, blocks, and ducts.

15. The method of removing contaminants from water of claim 14, wherein said pellets are a placed within a water-permeable housing which retains said structures when said housing is placed in water.

16. The method of removing contaminants from water of claim 15, wherein said pellets are substantially shaped as at least one of cylinders and spheres.

17. The method of removing contaminants from water of claim 13, wherein said metal carbonate is at least one of magnesium carbonate and lanthanum carbonate.

18. The method of removing contaminants from water of claim 13, wherein said structures are produced by the process of:
a. creating a slurry by mixing a diluent, powdered activated alumina, at least one of a powdered metal carbonate and a binder-metal carbonate mixture;
b. forming preliminary structure by forming said slurry into a shape;
c. calcining said preliminary structure so that only said activated alumina and said metal carbonate substantially remains.

19. The method of removing contaminants from water of claim 18, wherein said structures are produced from a slurry formed by the process of:
a. adding 10% to 50% water by mass to said powdered activated alumina and said powdered metal carbonate to create a pre-slurry of a desired consistency;
b. partially drying said pre-slurry;
c. grinding said pre-slurry into a granular paste; and
d. shaping said structure from said granular paste.

20. The method of removing contaminants from water of claim 19, wherein said binder is selected from the group consisting of cellulose and organic polymers.

21. A fertilizer comprising at least one of phosphates and ammonia desorbed from activated alumina used in conjunction with at least one substantially water insoluble metal carbonate in forming at least one porous structure which had previously adsorbed said at least one of said phosphates and said ammonia from aqueous media, wherein said structure possessed nanopores and a multiBET surface area of at least 20 m²/g.
